(19) United States
(12) Patent Application Publication
(10) Pub. No.: US 2026/0191278 A1
(43) Pub. Date: Jul. 9, 2026

(54) AEROSOL-GENERATING DEVICE WITH RADIOFREQUENCY ENERGY HARVESTING SYSTEM

(71) Applicant: Philip Morris Products S.A., Neuchatel (CH)

(72) Inventors: Rui Nuno Rodrigues Alves BATISTA, Morges (CH); Cristina FERRAZ RIGO, Pully (CH)

(73) Assignee: Philip Morris Products S.A., Neuchatel (CH)

(21) Appl. No.: 19/129,057

(22) PCT Filed: Dec. 11, 2023
(86) PCT No.: PCT/EP2023/085072

§ 371 Date: May 12, 2025

(30) Foreign Application Priority Data
Dec. 12, 2022 (EP) 22212772.2

(51) Int. Cl. A24F 40/90; A24F 40/65; H02J 50/00; H02J 50/20

(52) U.S. Cl. CPC A24F 40/90; A24F 40/65; H02J 50/001; H02J 50/20

(57) ABSTRACT

An aerosol-generating device is provided, including: a main body having a housing; a heating element arranged within the housing; a power supply and a secondary electrical consumer; and a radiofrequency energy harvesting system configured to: harvest electromagnetic energy from electromagnetic radiation, and only power the secondary electrical consumer, the secondary electrical consumer including a device configured to send out location information from the aerosol-generating device, and the device configured to send out location information being further configured to emit a radio frequency signal, which is a backscatter radio frequency signal.

The present invention relates to an aerosol-generating device. The present invention relates to an aerosol-generating system. The present invention relates to a charger for an aerosol-generating device. The present invention relates to a system comprising an aerosol-generating device and a charger.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device.

Aerosol-generating devices are usually powered by a rechargeable battery. In order to recharge this battery, the aerosol-generating device usually has to be connected to an electrical power plug or to a charger. During recharging of the battery, the aerosol-generating device usually cannot be used. This can prevent or postpone desired use of the aerosol-generating device. Therefore, the user needs to plan and organize when and where to recharge their device.

It would be desirable to have an aerosol-generating device with improved battery life. It would be desirable to have an aerosol-generating device with improved energy efficiency. It would be desirable to have an aerosol-generating device with improved energy supply to secondary systems.

According to an embodiment of the invention there is provided an aerosol-generating device. The aerosol-generating device comprises a main body having a housing and a heating element. The heating element is arranged within the housing. The aerosol-generating device further comprises one or both of a power supply and a secondary electrical consumer. The aerosol-generating device further comprises a radiofrequency energy harvesting system. The radiofrequency energy harvesting system is configured to harvest electromagnetic energy from electromagnetic radiation. The radiofrequency energy harvesting system is configured to one or both of recharge the power supply and power the secondary electrical consumer.

According to an embodiment of the invention there is provided an aerosol-generating device. The aerosol-generating device may comprise a main body having a housing and a heating element. The heating element may be arranged within the housing. The aerosol-generating device may further comprise one or both of a power supply and a secondary electrical consumer. The aerosol-generating device may further comprise a radiofrequency energy harvesting system. The radiofrequency energy harvesting system may be configured to harvest electromagnetic energy from electromagnetic radiation. The radiofrequency energy harvesting system may be configured to one or both of recharge the power supply and power the secondary electrical consumer.

By providing an aerosol-generating device comprising a radiofrequency energy harvesting system a device with improved battery life may be provided. By providing an aerosol-generating device comprising a radiofrequency energy harvesting system a device with improved energy efficiency may be provided. By providing an aerosol-generating device comprising a radiofrequency energy harvesting system a device with improved energy supply to secondary systems may be provided.

Radio frequency energy harvesting is a technology providing the generation of electrical energy from ambient/surrounding radio frequency signals. This energy can be used to create direct current. Ambient/surrounding radio frequency signals are for example Wi-Fi and wireless networks, signals from mobile phones or TV stations.

The radio frequency energy harvesting system may comprise one or both of a radiofrequency energy harvesting circuit, an impedance matching circuit, a rectifier circuit and a storage unit. The radiofrequency energy harvesting system may be configured to harvest electromagnetic energy from ambient electromagnetic radiation. Ambient electromagnetic radiation may be signals from Wi-Fi and wireless networks, mobile phones or TV stations.

The radiofrequency energy harvesting system may be configured to harvest electromagnetic energy from electromagnetic radiation in frequency ranges of between 0.8 GHz to 60 GHz, preferably of between 0.8 GHz to 6 GHz. The radiofrequency energy harvesting system may be configured to harvest electromagnetic energy from electromagnetic radiation having a frequency of one or both of 2.4 GHz and of 5 GHZ.

The radiofrequency energy harvesting system may be configured to harvest electromagnetic energy from ambient electromagnetic radiation in frequency ranges of between 0.8 GHz to 60 GHz, preferably of between 0.8 GHz to 6 GHz. The radiofrequency energy harvesting system may be configured to harvest electromagnetic energy from ambient electromagnetic radiation having a frequency of one or both of 2.4 GHz and of 5 GHz.

The power supply may comprise a battery. The power supply may be a lithium-ion battery. Alternatively, the power supply may be a nickel-metal hydride battery, a nickel cadmium battery, or a lithium-based battery, for example a lithium-cobalt, a lithium-iron-phosphate, lithium titanate or a lithium-polymer battery.

The main body may comprise a cavity configured for receiving an aerosol-generating article or a cartridge comprising aerosol-forming substrate. The cavity may be at least partly surrounded by the heating element. The cavity may be a heating chamber. The cavity may have an opening. The opening may be at a proximal end of the main body.

The heating element may be an indictive heating element. The heating element may comprise at least one inductor coil. The inductor coil may be at least partly arranged around the heating chamber of the main body. Alternatively, the heating element may comprise an electrically resistive heating element.

The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle. The housing may include a user interface to activate the aerosol-generating device, for example a button to initiate heating of the aerosol-generating device or a display to indicate a state of the aerosol-generating device or of the aerosol-forming substrate.

The aerosol-generating device may comprise a primary electrical consumer and a secondary electrical consumer. The primary electrical consumer may be the heating element. The primary electrical consumer may require at least 5 to 20 times more energy than the secondary electrical consumer, preferably at least 10 to 15 times more energy than the secondary electrical consumer.

The secondary electrical consumer may be partially powered by the radiofrequency energy harvesting system. The secondary electrical consumer may be solely powered by the radiofrequency energy harvesting system. By powering the secondary electrical consumer only by the radiofrequency energy harvesting system, an electrical connection from the power supply to the secondary electrical consumer may be omitted.

The secondary electrical consumer may comprise a sensor. The secondary electrical consumer may be a sensor. The sensor may comprise a capacitive sensor. The capacitive sensor may be configured to detect if a user is holding the aerosol-generating device.

The secondary electrical consumer may comprise a device for sending out location information of the aerosol-generating device. Thereby the aerosol-generating device may be localized even if the power supply is depleted. The device for sending out location information may be configured to emit a radio frequency signal, preferably a backscatter radio frequency signal. The backscatter radio frequency signal may comprise a unique identifier. The location of the aerosol-generating device may be localized via a smartphone. The location of the aerosol-generating device may be localized via a charger for charging the aerosol-generating device.

The secondary electrical consumer may comprise a charging indicator, preferably an optical charging indicator. The secondary electrical consumer may comprise one or both of a device for sending out location information from the aerosol-generating device and a charging indicator, preferably an optical charging indicator. The secondary electrical consumer may comprise a charging indicator and a capacitive sensor. The optical charging indicator may comprise a LED. The charging indicator may comprise a speaker. The secondary electrical consumer may be a charging indicator. The charging indicator may comprise a low battery indicator. The low battery indicator may warn the user when the battery level is low. The low battery indicator may indicate when the battery charge is below a certain battery charge, for example, below 20% or below 10%, or below 5%. The warning may be a specific periodic or persistent signal. The periodic or persistent signal may be a light signal or a sound signal. The signal itself may draw power from the battery, thereby the low battery may be further depleted. By supplying power to the charging indicator by the radiofrequency energy harvesting system, further depletion of the low battery may be prevented.

The aerosol-generating device may further comprise a controller. The controller may be configured to control the radiofrequency energy harvesting system to recharge the power supply, if the controller detects that the power supply is not fully charged. The controller may be configured to control activation of a puff sensor, if the capacitive sensor detects that a user is holding the aerosol-generating device. The controller may comprise a processor. The controller may be a processor. The processor may induce retroactive actions during, or after, processing signals.

The controller may be configured to control activation of the optical charging indicator if the power level of the power supply is below 50%, preferably below 40%, more preferably below 30%, most preferably below 20%.

The radiofrequency energy harvesting system may comprise an antenna. The antenna may be a transducer device. The antenna may convert ambient radio frequency into alternating current (AC). The antenna may be arranged embedded in or coated onto the inside of or directly abutting the housing of the aerosol-generating device. The housing may comprise the antenna. The housing may be the antenna. The antenna may be arranged at least partly around the cavity of the main body. The antenna may extend over at least 60%, preferably at least 70%, more preferably at least 80%, most preferably at least 85%, of the length of the housing of the aerosol-generating device. The length of the housing may be measured in a direction along a longitudinal axis of the aerosol-generating device. The at least one induction coil may be the antenna. Preferably, the at least one induction coil may be a flat induction coil being the antenna.

The secondary electrical consumer may comprise a capacitive sensor. The capacitive sensor may detect a contact of a hand or lip of a user on the main body of the aerosol-generating device. In case the capacitive sensor detects a contact, the radio frequency energy harvesting system may send a “wake-up” signal to the controller which then activates the puff sensor or increases the sampling frequency of the puff sensor.

In one embodiment the aerosol-generating device may comprises a puff sensor, a battery, a capacitive sensor, the radio frequency energy harvesting system and a controller. The puff sensor, the battery, the capacitive sensor and the radio frequency energy harvesting system are all connected to the controller. The puff sensor may be bi-directional connected to the controller. The capacitive sensor and the battery may be connected to the controller to allow a data transfer towards the controller. The radio frequency energy harvesting system may be additionally connected to the capacitive sensor, allowing data transfer from the radio frequency energy harvesting system towards the capacitive sensor. The battery and the low battery indicator may be both connected to the radio frequency energy harvesting system, allowing a data transfer from the radio frequency energy harvesting system towards them, respectively.

The radio frequency energy harvesting system may provide a primary task and a secondary task. The primary task of the radio frequency energy harvesting system may be to continuously recharge the power supply. The radio frequency energy harvesting system may recharge the power supply when the aerosol-generating device is not operated. The secondary task of the radio frequency energy harvesting system may be the powering of the secondary electrical consumer. The secondary electrical consumer may comprise one or both of a capacitive sensor and a charging indicator, preferably a capacitive sensor and a low battery indicator.

The radio frequency energy harvesting system may recharge the power supply if the battery is fully depleted. The radio frequency energy harvesting system may recharge the power supply if the battery charge is low, for example below 20%, 15% or 10% charge. The radio frequency energy harvesting system may recharge the power supply if the battery charge is not full.

The main body may comprise a charging port. The charging port may be located at a distal end of the main body. The charging port may be configured to charge the aerosol-generating device. Additionally or alternatively, the charging port may be configured to transfer data between the aerosol-generating device and an external electronic device, like for example a mobilephone.

The present invention further relates to an aerosol-generating system comprising the aerosol-generating device and an aerosol-generating article. The aerosol-generating article may comprise aerosol-forming substrate. The aerosol-generating article may be a rod-shaped article. The aerosol-generating device may comprise a cavity configured to receive the aerosol-generating article. The aerosol-generating article may be partly inserted into the cavity of the aerosol-generating device. The aerosol-generating article may comprise a filter portion and an aerosol-forming substrate portion. When the aerosol-generating article is inserted into the cavity of the aerosol-generating device, the user may puff on the filter portion of the aerosol-generating article. The heating element may comprise at least one inductor coil and the aerosol-generating article may comprise susceptor material.

The present invention further relates to a charger for the aerosol-generating device described herein. The charger may comprise a charger power supply. The charger may be configured to emit radiofrequency electromagnetic radiation with a frequency optimized for energy transfer to the radiofrequency energy harvesting system of the aerosol-generating device. The charger may comprise a radiofrequency emitter.

The charger may be a mobile charger. The charger may further comprise a charger radiofrequency energy harvesting system configuring for recharging the charger power supply.

The present invention further relates a system comprising the aerosol-generating device and the charger described herein. The secondary electrical consumer of the aerosol-generating device may comprise a device for sending out location information. The charger may be configured to emit a radio frequency seeking signal. The device for sending out location information may be configured to emit a backscatter radio frequency signal upon detection of the radio frequency seeking signal. The charger may be configured to one or both of identify and localize the aerosol-generating device upon detection of the backscatter radio frequency signal. Thereby a user may find the aerosol-generating device if it gets lost in an area surrounding the user while the battery is depleted. The charger may comprise at least one proximity LED, preferably a plurality of proximity LEDs. The localization of the aerosol-generating device may be detected by the charger in dependence of the weakening of the detected backscatter radio frequency signal. The proximity LEDs may indicate the localization of the aerosol-generating device, for example, by the intensity of a light signal and/or by varying a light pattern of the plurality of proximity LEDs.

As used herein, the term ‘proximal’ refers to a user-end, or mouth-end of the aerosol-generating device or system or a part or portion thereof, and the term ‘distal’ refers to the end opposite to the proximal end. When referring to the heating chamber, the term ‘proximal’ refers to the region closest to the open end of the cavity and the term ‘distal’ refers to the region closest to the closed end.

As used herein, the term ‘aerosol-forming substrate’ relates to a substrate capable of releasing volatile compounds that can form an aerosol or a vapor. Such volatile compounds may be released by heating the aerosol-forming substrate. The aerosol-forming substrate may be in solid form or may be in liquid form. The terms ‘aerosol’ and ‘vapor’ are used synonymously.

The aerosol-forming substrate may comprise nicotine. The nicotine-containing aerosol-forming substrate may be a nicotine salt matrix.

The aerosol-forming substrate may comprise plant-based material. The aerosol-forming substrate may comprise tobacco. The aerosol-forming substrate may comprise a tobacco-containing material including volatile tobacco flavour compounds which are released from the aerosol-forming substrate upon heating. Alternatively, the aerosol-forming substrate may comprise a non-tobacco material. The aerosol-forming substrate may comprise homogenised plant-based material. The aerosol-forming substrate may comprise homogenised tobacco material. Homogenised tobacco material may be formed by agglomerating particulate tobacco.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the aerosol-generating system. Suitable aerosol-formers are well known in the art and include, but are not limited to: polyhydric alcohols, such as triethylene glycol, 1,3-butanediol and glycerine; esters of polyhydric alcohols, such as glycerol mono-, di-or triacetate; and aliphatic esters of mono-, di-or polycarboxylic acids, such as dimethyl dodecanedioate and dimethyl tetradecanedioate. Preferred aerosol formers are polyhydric alcohols or mixtures thereof, such as triethylene glycol, 1,3-butanediol. Preferably, the aerosol former is glycerine. Where present, the homogenised tobacco material may have an aerosol-former content of equal to or greater than 5 percent by weight on a dry weight basis, and preferably from 5 percent to 30 percent by weight on a dry weight basis. The aerosol-forming substrate may comprise other additives and ingredients, such as flavourants.

As used herein, a ‘susceptor’ or ‘susceptor element’ means an element that heats up when subjected to an alternating magnetic field. This may be the result of eddy currents induced in the susceptor element, hysteresis losses, or both eddy currents and hysteresis losses. During use, the susceptor element is located in thermal contact or close thermal proximity with an aerosol-forming substrate received in the aerosol-generating article or cartridge. In this manner, the aerosol-forming substrate is heated by the susceptor such that an aerosol is formed.

The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The power supply may be a direct current (DC) power supply. In one embodiment, the power supply is a DC power supply having a DC supply voltage in the range of 2.5 Volts to 4.5 Volts and a DC supply current in the range of 1 Amp to 10 Amps (corresponding to a DC power supply in the range of 2.5 Watts to 45 Watts). The aerosol-generating device may advantageously comprise a direct current to alternating current (DC/AC) inverter for converting a DC current supplied by the DC power supply to an alternating current. The DC/AC converter may comprise a Class-D, Class-C or Class-E power amplifier. The AC power output of the DC/AC converter is supplied to the induction coil.

Features described in relation to one embodiment may equally be applied to other embodiments of the invention.

The invention will be further described, by way of example only, with reference to the accompanying drawings in which:

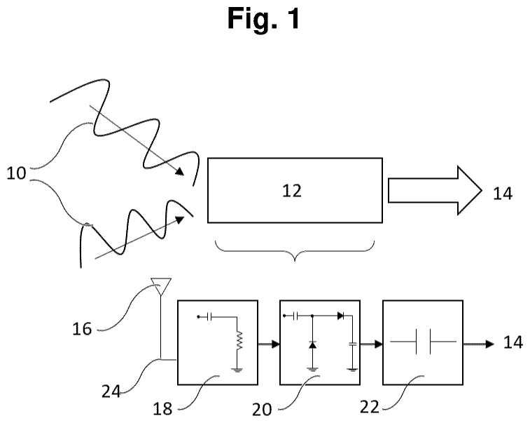

FIG. 1 shows a radio frequency energy harvesting system;

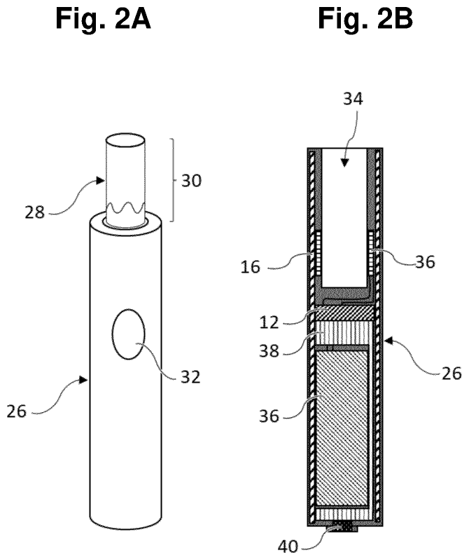

FIG. 2A shows a 3D view of an aerosol-generating device, FIG. 2B shows a cross sectional view of the aerosol-generating device;

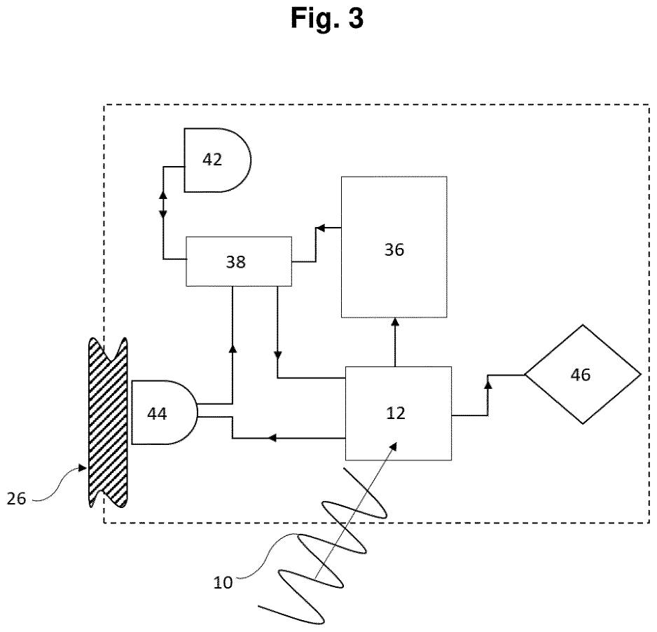

FIG. 3 shows the interplay of the electronical components of the aerosol-generating device;

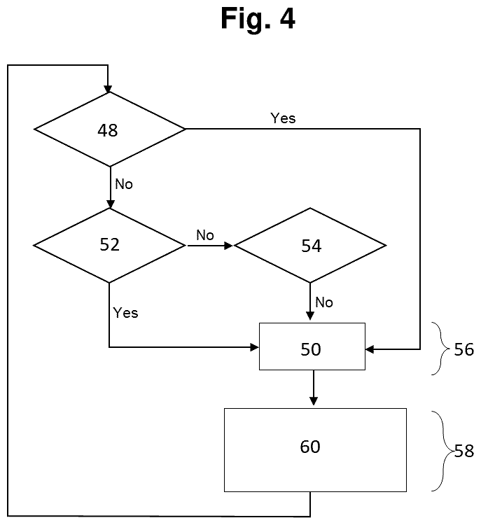

FIG. 4 shows a flow chart describing an algorithm used by an aerosol-generating device;

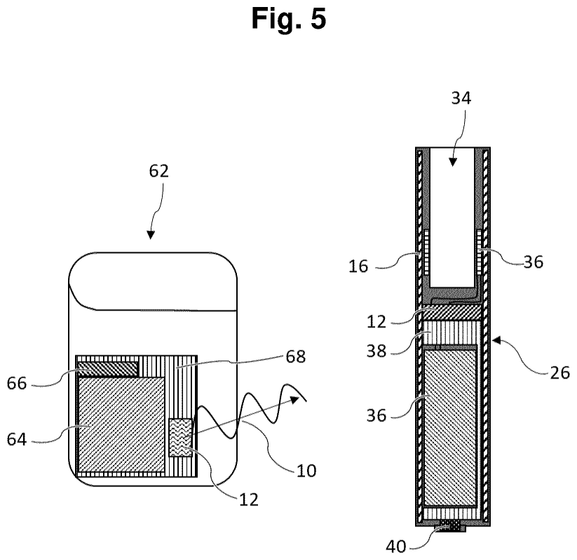

FIG. 5 shows a charger for an aerosol-generating device, and

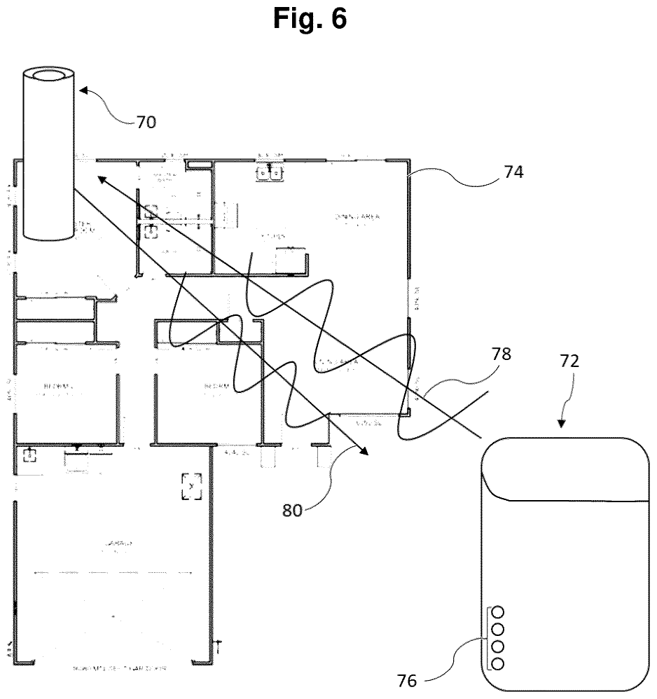

FIG. 6 shows a system comprising an aerosol-generating device and a charger.

In FIG. 1 the general working principle of a radio frequency energy harvesting system is shown. Ambient radio frequency signals 10, like for example Wi-Fi and wireless networks, signals from mobile phones or TV stations, radiate onto the radio frequency energy harvesting system 12 to generate a direct current (DC) 14. In more detail, the radio frequency energy harvesting system 12 comprises an antenna 16, an impedance matching circuit 18, a rectifier circuit 20 and a storage unit 22. The antenna 16 is a transducer device that captures the ambient radio frequency signals 10 and converts them into alternating current (AC) 24. The impedance matching circuit 18 adjusts a load impedance to the source 10. Thereby the maximum power can be transferred from the antenna 16 to a load. The rectifier circuit converts the AC 24 into DC 14. The storage unit 22 can be a capacitor. The storage unit 22 can store power to act as a power reserve when no external energy is available.

FIG. 2A shows a 3D view of an aerosol-generating device 26 comprising a main body and an aerosol-generating article 28. The aerosol-generating article 28 comprises a substrate portion (not shown) comprising aerosol-forming substrate and a mouthpiece portion 30. The main body of the aerosol-generating device 26 comprises a user interface 32 which is a button. FIG. 2B shows a cross sectional view of the aerosol-generating device 26. The device comprises a cavity 34 into which the aerosol-generating article 28 can be inserted. At least partially around the cavity 34 an inductor coil 36 is arranged. The inductor coil 36 can heat susceptor material (not shown) comprised in the aerosol-generating article 28.

The aerosol-generating device 26 further comprises an antenna 16. The antenna 16 is embedded in a coating of the main body of the aerosol-generating device 26. The antenna 16 encloses a power supply which is a battery 38, a controller 40, a radio frequency energy harvesting system 12 and a charging port 40. The charging port 40 can additionally also be a data port. The controller 38 is connected to both the battery 36, the radio frequency energy harvesting system 12 and the induction coil 36 via wirings.

FIG. 3 shows the interplay of the electronical components of the aerosol-generating device 26. FIG. 3 shows how the actions of the radio frequency energy harvesting system 12 can be organized according to the battery level of the aerosol-generating device 26. The individual electronical components of the aerosol-generating device 26 shown in FIG. 3 are the radio frequency energy harvesting system 12, the battery 36, the controller 38, a puff sensor 42, a capacitive sensor 44 and a charging indicator which is a low battery indicator 46. The low battery indicator 46 can be an LED or a speaker to indicate when the battery charge is below a is below a certain battery charge, for example, below 20% or below 10%, or below 5%. The radio frequency energy harvesting system 12 collects ambient radio frequency signals 10. The arrows represent a data transfer connection. The direction of the respective arrows shows the direction into which the data can be transferred.

The puff sensor 42, the battery 36, the capacitive sensor 44 and the radio frequency energy harvesting system 12 are both connected to the controller 38. The puff sensor 42 is bi-directional connected. The capacitive sensor 44 and the battery 36 are connected to allow a data transfer towards the controller 38. The radio frequency energy harvesting system 12 is additionally connected to the capacitive sensor 44, allowing data transfer from the radio frequency energy harvesting system 12 towards the capacitive sensor 44. The battery 36 and the low battery indicator 46 are both connected to the radio frequency energy harvesting system 12, allowing a data transfer from the radio frequency energy harvesting system 12 towards them, respectively. The capacitive sensor 44 detects the contact of the hand or lip of a user on the main body of the aerosol-generating device 26. In case the capacitive sensor 44 detects a contact, the radio frequency energy harvesting system 12 sends a “wake-up” signal to the controller 38 which then activates the puff sensor 42 or increases the sampling frequency of the puff sensor 42. The low battery indicator 46 indicates if the battery 36 is below a certain battery charge.

The primary task of the radio frequency energy harvesting system 12 is to continuously recharge the battery 36. The secondary task of the radio frequency energy harvesting system 12 is the powering of a secondary electrical consumer. Such a secondary electrical consumer can consist of one or both of the capacitive sensor 44 and the low battery indicator 46.

FIG. 4 shows a flow chart describing an algorithm that may be used by the aerosol-generating device 26 comprising the radio frequency energy harvesting system 12. Starting at box 48 there is the question if the battery is fully depleted. If so, the radio frequency energy harvesting system 12 recharges the battery 50. If not, in box 52 there is the question if the battery charge is low 52. If the battery charge is low, the radio frequency energy harvesting system 12 recharges the battery 50. If the battery charge is not low, then in box 54 there is the question if the battery is full. If the battery charge is not full, the radio frequency energy harvesting system 12 recharges the battery 50.

Charging the battery 50 is the main task 56 of the radio frequency energy harvesting system 12. The secondary task 58 of the radio frequency energy harvesting system 12 is to provide energy to one or both of the low battery indicator and the capacitive sensor 60.

FIG. 5 shows a charger 62 for an aerosol-generating device 26. The aerosol-generating device comprises the same components as discussed above. The charger 62 comprises electronics 66, an antenna 68 and a radio frequency energy harvesting system 12. The charger 62 can emit radio frequency signals 10 to transfer energy to the aerosol-generating device 26. The transmitted radio frequency signals 10 can then be transformed by the radio frequency energy harvesting system 12 of the aerosol-generating device to charge the battery 36 of the aerosol-generating device 26. Thereby no connections are needed and the aerosol-generating device can still be used during charging.

The charger 62 may comprise a radio frequency energy harvesting system 12 connected to the battery 64 by itself. Thereby the charger can charge itself by using ambient radio frequency signals 10.

FIG. 6 shows a system comprising an aerosol-generating device 70 and a charger 72. The aerosol-generating device 70 comprises a radio frequency energy harvesting system described above and a device for sending out location (not shown). The aerosol-generating device 70 is located in a room of a fictious house depicted by the floor plan 74. The charger 72 comprises proximity LEDs 76. If the battery of the aerosol-generating device 70 is depleted, a user can send a radio frequency seeking signal 78 emitted by the charger. The radio frequency energy harvesting system of the aerosol-generating device 70 can power the device for sending out location information of the aerosol-generating device 70 with energy even if the battery is depleted. Upon detection of the radio frequency seeking signal 78 by the aerosol-generating device 70, the device for sending out location information emits a backscatter radio frequency signal 80 to the charger. The backscatter radio frequency signal 80 comprises a unique identifier. Upon detection of the backscatter radio frequency signal 80, the charger 72 identifies the aerosol-generating device 70. The localization of the aerosol-generating device 70 can be detected by the charger 72 in dependence of the weakening of the detected backscatter radio frequency signal 80. The proximity LEDs 76 can indicate the localization of the aerosol-generating device 70, for example, by the intensity of a light signal and/or by varying a light pattern of the four LEDs 76.

1.-15. (canceled)

16. An aerosol-generating device, comprising:
a main body having a housing;
a heating element arranged within the housing;
a power supply and a secondary electrical consumer, and
a radiofrequency energy harvesting system,
wherein the radiofrequency energy harvesting system is configured to:
harvest electromagnetic energy from electromagnetic radiation, and only power the secondary electrical consumer,
wherein the secondary electrical consumer comprises a device configured to send out location information from the aerosol-generating device, and
wherein the device configured to send out location information is further configured to emit a radio frequency signal, which is a backscatter radio frequency signal.

17. The aerosol-generating device according to claim 16, wherein the secondary electrical consumer further comprises a sensor configured to detect if a user is holding the aerosol-generating device.

18. The aerosol-generating device according to claim 16, wherein the secondary electrical consumer further comprises a charging indicator.

19. The aerosol-generating device according to claim 16, wherein the electromagnetic radiation is ambient electromagnetic radiation.

20. The aerosol-generating device according to claim 16, wherein the radiofrequency energy harvesting system is further configured to harvest electromagnetic energy from electromagnetic radiation in frequency ranges of between 0.8 GHz to 60 GHz.

21. The aerosol-generating device according to claim 17, further comprising a controller.

22. The aerosol-generating device according to claim 21, wherein the controller is configured to control activation of a puff sensor, if the sensor detects that the user is holding the aerosol-generating device.

23. The aerosol-generating device according to claim 22, wherein the puff sensor is configured as a secondary electrical consumer at least partly powered by the radiofrequency energy harvesting system.

24. The aerosol-generating device according to claim 21,
wherein the secondary electrical consumer further comprises a charging indicator, and
wherein the controller is configured to control activation of the charging indicator if a power level of the power supply is below 50%.

25. The aerosol-generating device according to claim 16,
wherein the radiofrequency energy harvesting system comprises an antenna, and
wherein the antenna is arranged on, embedded in, or coated onto an inside of or directly abutting the housing.

26. The aerosol-generating device according to claim 25, wherein the antenna extends over at least 60% of a length of the housing.

27. A charger for the aerosol-generating device according to claim 16, the charger comprising a charger power supply and being configured to emit radiofrequency electromagnetic radiation with a frequency optimized for energy transfer to the radiofrequency energy harvesting system of the aerosol-generating device.

28. The charger according to claim 27,
wherein the charger is a mobile charger, and
wherein the charger further comprises a charger radiofrequency energy harvesting system configuring for recharging the charger power supply.

29. A system comprising the aerosol-generating device according to claim 16 and a charger for the aerosol-generating device,
the charger comprising a charger power supply and being configured to emit radiofrequency electromagnetic radiation with a frequency optimized for energy transfer to the radiofrequency energy harvesting system of the aerosol-generating device,
wherein the secondary electrical consumer comprises a device configured to send out location information of the aerosol-generating device,
wherein the charger is configured to emit a radio frequency seeking signal,
wherein the device configured to send out location information is further configured to emit a backscatter radio frequency signal upon detection of a radio frequency seeking signal, and
wherein the charger is further configured to one or both of identify and localize the aerosol-generating device upon detection of the backscatter radio frequency signal.
